(19) United States
(12) Patent Application Publication
(10) Pub. No.: US 2005/0010473 A1
(43) Pub. Date: Jan. 13, 2005

(54) Method of providing customized coupon cards

(76) Inventor: Gregory McLaughlin, Highland, UT (US)

Correspondence Address: Brent T. Winder;Jones, Waldo, Holbrook & McDonough, Suite 1500, 170 South Main Street, Salt Lake City, UT, 84101, US

(21) Appl. No.: 10/617,508

(22) Filed: Jul. 11, 2003

(51) Int. Cl. G06F 17/60

(52) U.S. Cl. 705/14

(57) ABSTRACT

A method of marketing goods and/or services using discount purchasing incentives. The method provides customized discount coupon cards, books, or similar media, designed and arranged to carry and display a list of participating vendors, the cards containing a number of opportunities to redeem or otherwise utilize the designated discount at each respective vendor's place of business, or website. A graphical user interface and plurality of coupon carrying media support the ability of a consumer to personally customize any number of discounted purchase offers by choosing from a list of categories and sub-categories of manufacturer or retailer discount offers displayed on a network, such as the world wide web. After selecting offers that have been posted by local or national merchants, the specific discount information may be transmitted to an offer database, whereupon customized discount coupon cards, books, or other offer carrying media may be created for distribution to the consumer. Each customized card, or book etc., may be designed to display the specific offers chosen by the consumer and is transmitted to an in-house or outsourced printer, or encoder, for creation. The consumer's choices, geographic location, and other demographic information may be stored in a selections database designed to transmit the coupon utilization and ultimate sales information back to the manufacturers and retailers that provided the original discount offers.

### FIELD OF THE INVENTION

The present invention relates generally to a method of marketing goods and/or services using discount purchasing incentives. Specifically, the present illustrated embodiment(s) involve(s) a method of creating and providing customized discount coupon cards, books, or similar media that carry a list of participating vendors, and a number of opportunities to redeem or otherwise utilize the designated discount at each respective vendor's place of business or website.

### BACKGROUND OF THE ILLUSTRATED, EMBODIMENT(S) AND PRIOR ART

Coupons, as typically used by retailers, have been utilized as a popular form of advertising and promotion. Coupons and similar offers are commonly distributed in newspapers, periodicals, flyers, websites, and in other graphical media. Oftentimes, coupons are also compiled into booklets that are sold or otherwise distributed to consumers as part of a promotion, such as “Happenings Coupon Booklets” for example. Consumers then carry the coupons of interest, as applicable to their particular offers of interest, for redemption at the participating retailer's, or manufacturer's, establishment. For retailers, this method of advertising is effective in attracting new business to the retail outlet or store. For product manufacturers, these coupons may increase sales and extend product exposure.

However, under typical and well-known methods, which are primarily paper-based discount marketing strategies, there are recognized concerns regarding: 1) the cost to the manufacturer and/or retailer for distributing coupons to a wide audience with relatively small rates of redemption; 2) the ability of such methods to attract and maintain repeat customers; 3) the failure of these known methods to provide consumer information, including demographics and consumer preferences, back to the manufacturers and/or retailers; 4) the amount of time required for consumers to search for products/offers which are of interest to them within the promotional publication; and 5) the rates of misredemption and fraudulent redemption are high for coupons and similar discount promotions offered through mass mailings.

Moreover, as is seen in the prior art record, many coupon designs and methods offer a wide variety of products, many of which may not be of interest to individual consumers. This is especially true with respect to coupon compilation booklets. As a result, many discount coupon advertisements or marketing methods are grossly inefficient and are not tailored to the individual tastes of target consumers. Thus, it can be clearly recognized that there is a need for a method of discount-based marketing and/or advertising that may be customized to the specific buying habits and tastes of individual consumers. Further, there is a need for a method of discount based marketing that encourages repeat purchasing and purchases of non-discounted items.

As background and supporting art, the following United States patents are hereby incorporated by reference for their supporting teachings:
1) U.S. Pat. No. 6,450,407 issued to Freeman et al. discloses a method and system for providing advertisement information on chip cards that additionally involves an electronic money rebate to the consumer, and for the distribution, accounting, and recovery of the associated electronic money rebates;
2) U.S. Pat. No. 6,035,280 issued to Christensen discloses a method and apparatus for distributing, generating, and redeeming discount Virtual Coupons, rebate or gift certificates or the like which may be used in conjunction with a frequency card program or the like;
3) U.S. Pat. No. 6,467,686 issued to Guthrie et al. discloses a system and method for managing the coupon redemption process electronically;
4) U.S. Pat. No. 5,865,470 issued to Thompson discloses a coupon redemption card and tracking system including a credit card sized redemption coupon card used by the customer, and a tracking sheet used by the redemption center, such as a restaurant;
5) U.S. Pat. No. 5,501,491 issued to Thompson discloses a coupon redemption card and tracking system including a credit card sized redemption coupon card used by the customer, and a tracking sheet used by the redemption center, such as a restaurant; and
6) U.S. Pat. No. 6,183,017 issued to Najor et al. discloses a card, purchased by a user, to make pre-paid telephone calls via a telephone service provider system associated with the issuer of the card.

It is believed that all of the listed patents do not anticipate or make obvious the disclosed preferred embodiment(s).

### SUMMARY OF THE ILLUSTRATED EMBODIMENT(S)

The present invention relates generally to a method of marketing goods and/or services using discount purchasing incentives. The present illustrated embodiment(s) involve(s) a method of creating and providing customized discount coupon cards, books, or similar media that are designed and arranged to carry and display a list of participating vendors, and a number of opportunities to redeem or otherwise utilize the designated discount at each respective vendor's place of business, or website.

More particularly, a method with a corresponding graphical user interface and plurality of coupon carrying media is described; wherein, a consumer may personally customize any number of discounted purchase offers by choosing from a list of categories and sub-categories of manufacturer or retailer discount offers displayed on a network, such as the world wide web. After selecting offers that have been posted by local or national merchants, the specific discount information may be transmitted to an offer database, whereupon customized discount coupon cards, books, or other offer carrying media may be created for distribution to the consumer. Each customized card, or book etc., may be designed to display the specific offers chosen by the consumer and is transmitted to an in-house or outsourced printer, or encoder, for creation.

Further, the consumer's choices, geographic location, and other demographic information may be stored in a selections database designed to transmit the coupon utilization and ultimate sales information back to the manufacturers and retailers that provided the original discount offers. This information can be utilized to target and identify valuable repeat consumers in the future, thereby increasing advertising efficiency, and reducing costs, such as mass mailings and low redemption rates. In addition, consumer satisfaction may be maximized and the opportunity for misredemption and fraud may be drastically reduced because the creation of discount coupon cards, books, or other related media may be controlled by the in-house or outsourced card printer.

Additional features and advantages of the invention will be set forth in the detailed description which follows, taken in conjunction with the accompanying drawings, which together illustrate by way of example, the features of the invention.

### BRIEF DESCRIPTION OF THE FIGURES

The prior features of the summary of the illustrated embodiment(s) will become more evident upon examination of the following detailed description in conjunction with the following figures, wherein like element numbers represent like elements throughout:

FIG. 1 represents an illustration of a diagram describing the general method for collecting offers of the present invention;

FIG. 2 represents an illustration of diagram describing the general method and process for customizing coupons and/or discount offers for a plurality of users of the present invention; and

FIG. 3 represents an illustration of a cardstock multi-fold discount coupon card ready for distribution to an end user of the present invention.

### DETAILED DESCRIPTION OF THE ILLUSTRATED EMBODIMENT(S)

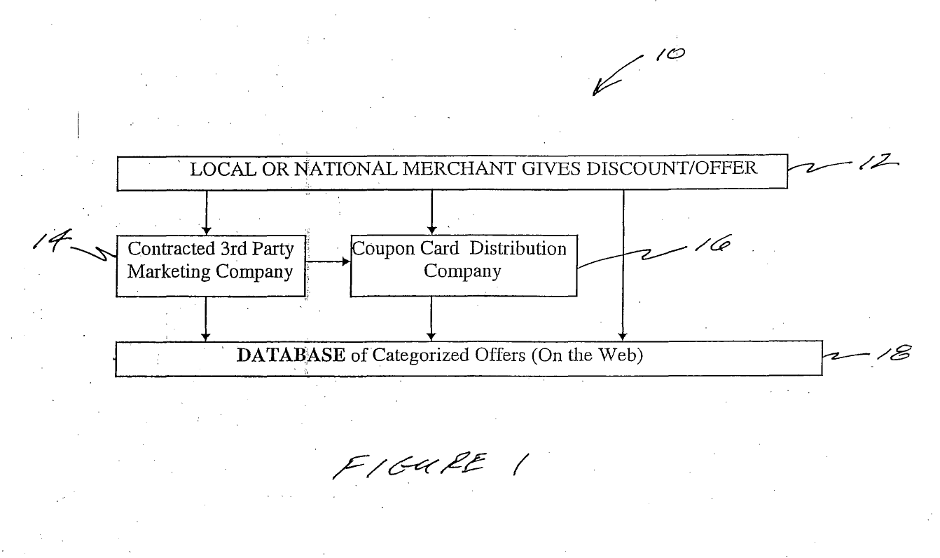

For the purpose of promoting an understanding of some of the principles of the illustrated embodiment(s), reference will now be made to exemplary embodiment(s) that are illustrated in the figures, and specific language will be used to describe the same. It will nevertheless be understood that no limitation of the scope of the claims is thereby intended. Any alterations and further modifications of the inventive features illustrated herein, and any additional applications of these principles, which would occur to one skilled in the relevant art after having possession of this disclosure, are to be considered well within the scope of this invention. Reference will now be made to all of the FIGS. 1 through 3, of the present invention, wherein like element numbers represent like elements throughout.

Referring to FIG. 1, a general method of collecting offers 10 of the present invention is shown and described. The general method of collecting offers 10, as initially required in providing customized discount coupon offers to a plurlaity of users, first involves a presentation of offer 12. The presentation of offer 12 may represent a single offer, or multiple offers, extended by local and/or national merchants or manufacturers to purchase products or services at discount prices. These offers may include products and services from a wide array of categories including, but not limited to: restaurants, entertainment, retail shopping, hotel and travel, and a wide array of other miscellaneous products and services.

A marketing subcontractor 14 may be employed to undertake the compiling, advertising, or distribution of the merchant's or manufacturer's product and/or service offers. Similarly, a coupon card distribution company 16, which represents a unique entity organized to process, customize, and distibute the presentation of offers 12 and any residual offers received through the marketing subcontractor(s) 14, may also be employed to undertake the compiling, advertising, or distribution of the merchant's or manufacturer's product and/or service offers. The coupon card distribution company 16 may also receive offers from the marketing subcontractor 14, upon which the coupon card distribution company 16 then processes, customizes, and distributes the coupons received thereby.

Referring again to FIG. 1, an offer database 18 is shown, which represents an electronic collection of offers received by local or national merchants through a presentation of offer 12, or through the marketing subcontractor 14 and/or coupon card distribution company 16. The offer database may be created for and displayed on the world wibe web or similar network via a graphical user interface to facilitate display and customized management of the information. The offer database 18 may be structured so that each offer that is recorded and stored may be categorized into specific categories and sub-categories, such as are identified below, for example only:
A. Restaurants
   All Categories
   Fast Food
      All Categories
      American
      Asian
      French
      Greek
      Indian
      Italian
      Mexican
      Middle Eastern
      Steak & Seafood
      Miscellaneous
   Casual Food and Fine Food
      All Categories
      American
      Asian
      French
      Greek
      Indian
      Italian
      Mexican
      Middle Eastern
      Steak & Seafood
      Miscellaneous
   Fine Dining
      All Categories
      American
      Asian
      French
      Greek
      Indian
      Italian
      Mexican
      Middle Eastern
      Steak & Seafood
      Miscellaneous
B. Entertainment
   All Categories
   Attractions
   Bowling
   Golf
   Movies & Videos
   Outdoor Recreation
   Fine Arts/Museums/Concerts
   Special Events
   Sporting Events
   Theme Parks & Family Fun Centers
   Miscellaneous
C. Retail Shops & Services
   All Categories
   Automotive
   Clothing
   Dry Cleaning
   Grocery
   Health & Beauty
   Home & Garden
   Music
   Retail
   Miscellaneous
D. Hotel & Travel
   Hotels
   Condo & Resorts
   Airfare
   Car Rental
   Cruises
E. Miscellaneous

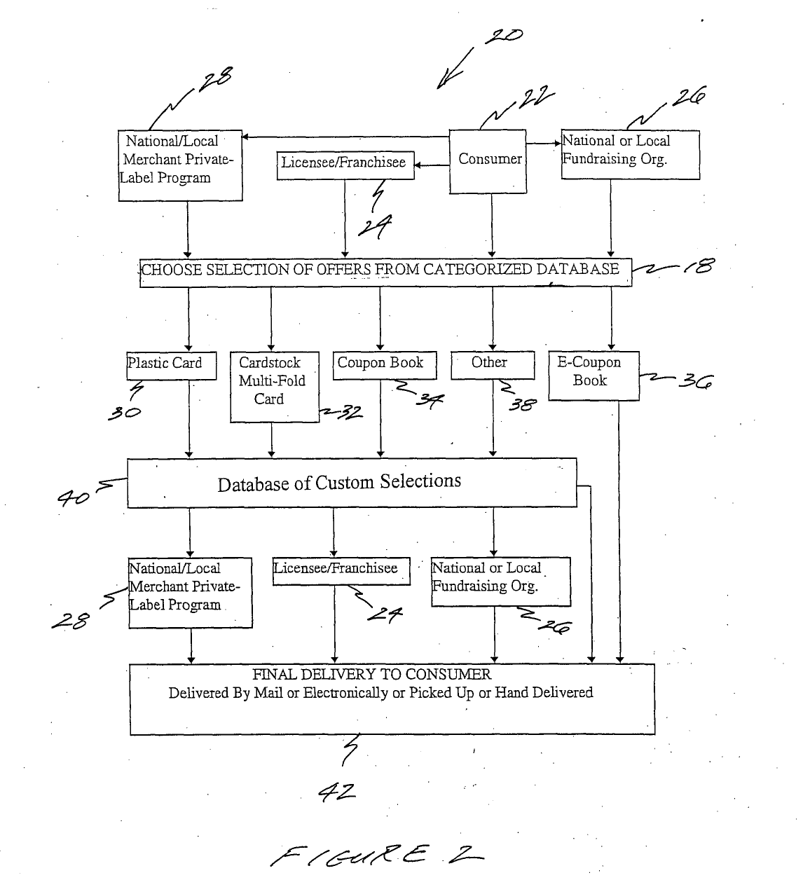

Referring now to FIG. 2, a general method and process for customizing coupons and/or discount offers for a plurality of users is shown and described. From the offer database 18, a series of persons and/or entities may select specific or general categories and/or sub-categories of discount offers. More specifically, this group includes, but is not limited to: consumers 22, licensees/franchisees 24, national or local fundraising organizations 26, and national or local merchants 28. From the offer database 18, which may be made available on the web, local area network, or similar medium, a consumer 22 may select specific categories and/or subcategories of discount coupon offers for which a compilation of the same will be prepared and packaged. Similarly, licensees or franchisees 24 of the coupon card distribution company 16 may select and customize a series of offers from the offer database 18 to suit the particular needs of their target audiences. For example, a national coupon distributor may subscribe to develop a customized package of coupons for retail shoppers in a particular demographic. Ultimately, however, the present method is a consumer driven process. In most instances, licensees or franchisees 24, will provide their customers with the option of accessing the offer database 18 of the present invention through a shared network, such as a link on the franchisee's or licensee's 24 website.

In addition, national or local fundraising organizations 26, such as Unicef or United Way, may similarly select and customize discount coupon offers from the offer database 18 in order to develop coupon products to offer for sale. The national or local merchants program 28 allows national or local vendors, such as McDonalds or Mail Boxes etc., to create co-branded packages, customized to the specific discounts offered by the vendor. For example, a fast food vendor may develop a customized coupon card for certain types of food products, or, alternatively, for persons living within particular geograhic boundaries. However, as noted above for the licensee or franchisee 24, the present method is primarily a consumer driven process. Thus, most national or local fundraising organizations 26 and national or local merchants 28 will provide their customers with the option of accessing the offer database 18 of the present invention through a shared network, such as a link on the participating organization's website.

A series of card media are represented, which media include, but are not limited to the following types illustrated: plastic cards 30, cardstock multi-fold cards 32, coupon books 34, electronic coupon books 36, and other media 38. All of the card media represented will display a collection of the offers chosen by the person or entity ordering the same. For example, if a franchisee or licensee 24 selected all casual dining offers from the offer database 18, all of the offers recorded and stored in that category will be transmitted to the card medium as selected by the franchisee or licensee 24. The plastic card 30 medium is a laminated plastic card, or similar material, that bears the custom selections of the ordering party. The cardstock multi-fold card 32 is a folding card, made from cardstock or similar grade paper, that bears the custom selections of the ordering party. The coupon book 34 is a bound book of pages that bears the custom selections of the ordering party. The electronic coupon book 36 is a compilation of the offers selected by the ordering party as stored electronically on a hard drive, personal digital assistant, card chip, or similar memory storage device.

A record or database of custom selections 40 made by the consumers 22, licensees/franchisees 24, national or local fundraising organizations 26, and/or national or local merchants 28 may be transmitted back to the local or national manufacturers or retailers who have made presentations of offer 12 (FIG. 1). In addition, this information may also be relayed back to the marketing subcontractors 14, and to the coupon card distribution company 16 for statistical analysis. This information may be valuable in determining what products or services are in highest demand, and the demographics surrounding the persons or entities making selections. This information as found in the database of custom selections 40 may be transmitted via the world wibe web, a local area network, fax, mail, or other similar means of distribution.

Upon receipt of the custom selections and card media of a particular order, the coupon card distribution company 16, national or local merchants 28, licensees/franchisees 24, or national or local fundraising organizations 26 may prepare the card media for distribution to the target audience. Similarly, the completed card media may be delivered directly to the consumer 22 through final delivery 42. The form of delivery may be made by mail, electronic mail or transmission, or in person.

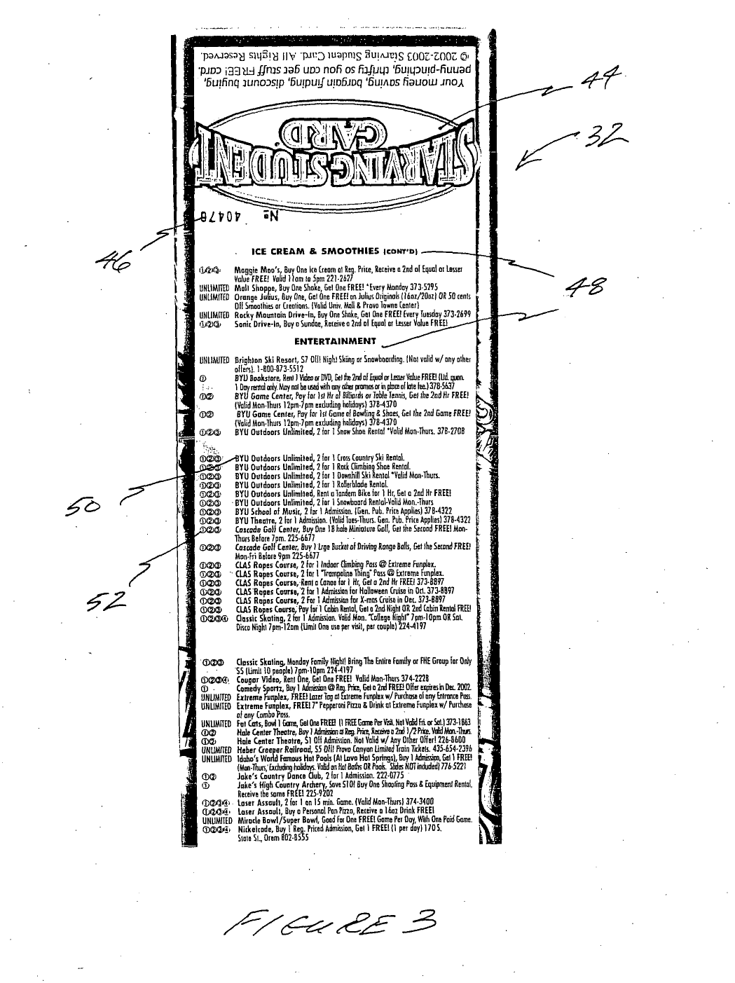

Referring now to FIG. 3, a sample cardstock multi-fold card 32 is illustrated. A card title 44 bears the name of the coupon card distribution company 16 at a top portion of the cardstock multi-fold card 32 (“Starving Student Card” for the present illustration). A card tracking number 46 allows each card to be identified and tracked from the point of sale. A series of categories 48 may be added to customize and specialize the card and to identify the kinds of goods and/or services offered. A series of participating vendors 50 may are shown under each category 48. In order to limit the use of the card to the number of offers extended by the vendors, a series of use bubbles 52 are included next to each vendor 50 for indicating the actual usage of each vendor's offer.

The general method and process for customizing discount coupon cards, via a graphical user interface, for consumers 22, licensees/franchisees 24, national or local fundraising organizations 26, and national or local merchants 28 involves, but is not limited to or constrained by, the following steps (not necessarily in specific order):
1. Log on to Web Site or Local Network.
2. Enter Regional Indicator. The regional indicator may be any sort of information that correlates the user to a geographical area. Examples of indicators include, but are not limited to, state, zip code, area code, city, county, address etc. This will bring up any national and local offers that are available for selection in that region.
3. Select One of the Following Options:
   A. Create Your Own Discount Card—This will prompt the user to select plastic 30 or paper 32 card mediums (FIG. 2).
   B. Create Your Own Coupon Book 34
   C. Create Your Own Electronic E-Coupon Book 36—This will prompt the user to print his/her own coupon book at home, or to download the information to a secondary memory storage device.
4. View Selections Page. This page displays the selections that the consumers 22 will be able to choose from, including a selection of sub-categorized national and local merchants offers. The national and local merchants' offers may be automatically alphabetized and categorized in the format selected by a user.
5. Select the Categories and Sub-categories of Interest. The specific items within the categories and sub-categories are as listed above.
6. View Pricing. Depending on the number of offers selected, the appropriate medium (plastic card 30, cardstock 32, coupon book 34, e-coupon book 36, or other 38) may be displayed with the respective pricing information.
7. Select Type of Card Design. This page allows a user to choose background colors, background design, and the name to appear on the card.
8. View Overview of Service. This page allows a user to view a summary of the selections, and the type of membership services selected.
9. Preview Proposed Product. This page allows a user to view the finished product as proposed.
10. Select Shipping Options. This page allows a user to select a method of delivery, such as mail, local print, hand delivery, pick up, or download.
11. Select Payment Option. This page allows a user to select a form of payment for he service, such as credit card, check, or other.
12. Payment Received. This page displays a confirmation of the payment as received, which authorizes delivery of the completed card to the user.
13. Product(s) Shipped to Consumer 22.

### REMARKS ABOUT THE ILLUSTRATED EMBODIMENT(S)

The illustrated embodiment(s) have taught several improvements over the prior art that will be readily understood by a skilled artisan after review of the present disclosure. For example, it has been discussed that the unique method of allowing consumers 22, licensees/franchisees 24, national or local fundraising organizations 26, and national or local merchants 28 to customize discount offers into a single coupon medium provides several benefits. Among these, the following benefits may apply: the present method targets a much larger audience by potentially focusing on national chains; the present method provides greater value to consumers 22, particularly perceived value of the offers tailored to their specific interests; the present method gives consumers 22 more discount options and choices; the present method gives retailers and manufacturers more opportunities to back end other products and promotions; the present method promotes overall consumption of goods and services; the present method promotes greater fundraiser interest and/or contributions; the present method provides “easy-to-create” co-branding programs; the present method encourages potential licensing and/or private labeling; the present method provides greater value for franchises with national backing; and the present method creates greater long term value for participating retailers and/or manufacturers.

Based on the reasons outline above, the present invention reduces costs to manufacturers and/or retailers who presently distribute mass quantities of coupons to a wide audience but suffer from relatively low rates of redemption; attracts and maintains repeat customers; provides consumer information, including demographics and consumer preferences, back to the manufacturers and/or retailers; reduces the amount of time required for consumers to search for products/offers which are of interest to them within promotional publications; increases the exposure of discount offers to consumers, thereby potentially allowing consumers to save money on a larger volume of products purchased; and reduces the rates of misredemption and fraudulent redemption for coupons and similar discount promotions offered through mass mailings.

It is pointed out, if it has not already been made clear, that the backbone of the illustrated embodiment(s) is the ability of the present invention to allow consumers 22, licensees/franchisees 24, national or local fundraising organizations 26, and national or local merchants 28 to customize their own coupon cards, or other types of offer compilations, to reflect the types of items, products, and/or services that they are desirous of purchasing or selling at a discount. Ultimately, however, it should be noted that the present method is primarily a consumer driven process. Licensees or franchisees 24, national or local fundraising organizations 26, and national or local merchants generate sales for their respective organizations through consumer purchases. Thus, these entities may utilize the present method by providing access to the offer database 18 through a shared network, or similar vehicle. The consumer 22 may then customize his/her package of discount offers to suit his or her particular needs. As a result, this information may be received by retailers and manufacturers for further marketing of goods and services, as well as generating income for fundraising organizations 26, coupon card distribution companies 16, and marketing contractors 14.

### VARIATIONS OF THE ILLUSTRATED EMBODIMENT(S)

It is understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements.

For example, although the illustrative embodiment(s) have/has described the use of a graphical user interface and electronic databases for display and storage of offers and selections, a paper model may also be utilized within the scope of the present invention. More specifically, a book or compilation of offers may be developed for persons of a particular demographic that may be utilized in lieu of a graphical user interface. Similarly, selections may be mailed or recorded in written form by a user in lieu of making electronic elections on a web site.

The present invention also contemplates the use of portable kiosks as a method of both allowing a consumer to view and choose from a database of offers through a graphical user interface contained within a terminal in the kiosk, and delivering a customized discount coupon card to the consumer at the point of sale. For example, it is contemplated that, as a form of delivery, a portable kiosk may process a consumer's requests and print out a coupon card for immediate use from an integrated printer contained with the kiosk.

In addition, the present method contemplates the use of a magnetic memory strip to be integrated into a coupon card or book, wherein the magnetic strip may carry individual demographic information about the user and the specific details regarding use of the offers contained therein. The information contained within the magnetic memory strip may then be uploaded to a network of manufacturers, retailers, licensees, coupon card distribution companies, or other entities requiring the same information.

Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function, and manner of operation, assembly, and use may be made, without departing from the principles and concepts of the invention as set forth in the claims.

1. A method of providing a customized compilation of discount purchase offers to a user, the method comprising the steps of:
a) collecting one or more discount purchase offers from a merchant;
b) assimilating the collected discount purchase offers into an offer database;
c) allowing the user to select one or more desired offers from the offer database;
d) allowing the user to select a medium for display and storage of the compilation of discount purchase offers;
e) delivering the customized compilation of discount purchase offers, as embedded upon the selected medium, to the user.

2. The method of claim 1, wherein the desired offers are categorized.

3. The method of claim 1, wherein the compilation of discount purchase offers may be assimilated by a marketing subcontractor.

4. The method of claim 1, wherein the compilation of discount purchase offers may be assimilated by a coupon card distribution company.

5. The method of claim 1, wherein the user is a local or national merchant.

6. The method of claim 1, wherein the user is a licensee.

7. The method of claim 1, wherein the user is a franchisee.

8. The method of claim 1, wherein the user is a local or national fundraising organization.

9. The method of claim 1, wherein the medium for display and storage of the compilation of discount purchase offers is a cardstock multi-fold card.

10. The method of claim 1, wherein the medium for display and storage of the compilation of discount purchase offers is a plastic card.

11. The method of claim 1, wherein the medium for display and storage of the compilation of discount purchase offers is a coupon book.

12. The method of claim 1, wherein the medium for display and storage of the compilation of discount purchase offers is an electronic memory storage device.

13. A method of providing customized coupon cards to a user via a graphical user interface, the method comprising the steps of:
a) prompting the user to log on to a website;
b) prompting the user to enter a regional indicator;
c) prompting the user to select a card medium;
d) displaying a plurality of discount purchase offers from national and local merchants that the user will be able to choose from;
e) prompting the user to select one or more discount purchase offers;
f) displaying pricing information corresponding to the discount purchase offers selected;
g) prompting the user to select a card design;
h) displaying a preview of the offers and card design selected;
i) displaying an overview of the offers and card design selected;
j) prompting the user to select a form of delivery;
k) prompting a user to select a form of payment;
l) displaying a confirmation of payment received; and
m) delivering the selected offers and card design to the user.

14. The method of claim 13, wherein the national and local merchants' offers may be automatically alphabetized and categorized in a format selected by the user.

15. The method of claim 13, wherein the card medium is a cardstock multi-fold card.

16. The method of claim 13, wherein the card medium is a plastic card.

17. The method of claim 13, wherein the card medium is a coupon book.

18. The method of claim 13, wherein the card medium is an electronic memory storage device.
